(19) United States
(12) Patent Application Publication
(10) Pub. No.: US 2015/0089626 A1
(43) Pub. Date: Mar. 26, 2015

(54) SYSTEM AND METHOD PROVIDING MARKETPLACE FOR BIG DATA APPLICATIONS

(71) Applicants: Fred Korangy, Annapolis, MD (US); Hamed Ghasemzadeh, Tehran (IR); Mohsen Arjmandi, Tehran (IR); Reza Azmi, Tehran (IR)

(72) Inventors: Fred Korangy, Annapolis, MD (US); Hamed Ghasemzadeh, Tehran (IR); Mohsen Arjmandi, Tehran (IR); Reza Azmi, Tehran (IR)

(73) Assignee: Fred Korangy, Annapolis, MD (US)

(21) Appl. No.: 14/531,982

(22) Filed: Nov. 3, 2014

(51) Int. Cl. H04L 12/911; G06Q 30/06; H04L 29/06

(52) U.S. Cl. CPC H04L 47/70; H04L 63/02; G06Q 30/0601
USPC 726/12; 709/226

(57) ABSTRACT

The embodiments herein disclose a system and method for providing a marketplace for Big Data applications. The system facilitates a repository of applications, data sets, process compositions and extension modules received from the various vendors. The assets provided by the marketplace are deployed upon receiving the requests on public and private clouds. The marketplace comprises the algorithms, data sets and software systems to generate, share and save the insights for a plurality of cloud users. The system provides Big Data applications on demand from the cloud users and installs the requested application on a dedicated platform adopted for online Big Data processing.

### CROSS-REFERENCE TO RELATED APPLICATION

The present application claims the priority of the U.S. Non Provisional patent of application with Ser. No. 14/457,147 filed on Aug. 12, 2014 which claims priority of a U.S. Provisional application with Ser. No. 61/864,687, and the contents of which are incorporated by reference herein.

### BACKGROUND

1. Technical Field

The embodiments herein generally relate to a field of cloud computing. The embodiments herein particularly relate to a platform for Big Data applications. The embodiments herein more particularly relate to a system and method for providing a marketplace for Big Data applications.

2. Description of the Related Art

The amount of data generated by sensors, machines, and individuals increases exponentially. The Intelligence, Surveillance and Reconnaissance (ISR) platforms have been moved towards higher resolution sensors and persistence surveillance. This has lead to the collection of enormous volume of data. Similarly, enterprises collect the large amounts of operational data from Information Technology (IT) systems with the goal of improving operations and cyber security. Finally, the data generated by people, especially in the context of social media explodes heavily. This flow of multi-source data leads to an opportunity to extract real time information that is immediately relevant to users.

Big data includes information garnered from social media, data from internet-enabled devices (including smart phones and tablets), machine data, video and voice recordings, and the continued preservation and logging of structured and unstructured data. Big data refers to the dynamic, large and disparate volumes of data created by people, tools and machines which are distributed over a set of storages. The data gathered may be stored beforehand or may be a continuous stream to be accessed, stored and analyzed with distributed algorithms and frameworks. Big Data analytics inherently requires a set of distributed computing, networking and storage resources that may be available locally or to be rented from a cloud infrastructure. In this manner, Big Data is related to cloud computing.

The ultimate objective of Big Data market is to gain effective advantages in terms of saving time and cost. It is more convenient and easy to use system to handle a processing of large data assets using an efficient software stack and hardware platform. The Big Data processing generates insights to increase a performance of business processes and increases system wide optimization parameters to provide better tools for managers to adjust decisions operationally and strategically. Applications and algorithms are required to process Big Data. Such applications and algorithms use Big Data platforms for computations and data organizations.

The aforementioned drawbacks are responsible for creating a need for a system and method for deploying a marketplace for Big Data application to generate and share insights for the users. Further there is a need for a centralized system that eliminates a need for an on-site administration of the Big Data platform and applications.

The above mentioned shortcomings, disadvantages and problems are addressed herein and which will be understood by reading and studying the following specification.

### OBJECTIVES OF THE EMBODIMENTS HEREIN

The primary object of the embodiments herein is to provide a deployable marketplace for Big Data application.

Another object of the embodiments herein is to provide a repository for applications, data sets, process compositions and required platform and extensions modules for Big Data processing.

Yet another object of the present invention is to provide a platform facilitating deployable assets which are provided upon request from private and public clouds.

Yet another object of the embodiments herein is to provide a platform which creates trust between Big Data users and enable secure communication between the users.

Yet another object of the embodiments herein is to provide a marketplace which is adapted to evolution that is having reputable algorithms, data sets and schemes.

Yet another embodiment of the present invention is to integrate private infrastructure and public infrastructure in a seamless manner.

Yet another embodiment of the present invention is to provide pervasive access to algorithms, data sets and schemes.

Yet another embodiment of the present invention is to provide a marketplace which facilitates renting data sets.

Yet another embodiment of the present invention is to enable the modules and elements of the marketplace interoperable even when the modules and elements are from different vendors.

These and other objects and advantages of the embodiments herein will become readily apparent from the following detailed description taken in conjunction with the accompanying drawings.

### SUMMARY

The various embodiments herein disclose a system for providing a marketplace for Big Data applications. The system comprises a cloud infrastructure configured to adapt, port and deploy Big Data applications to a plurality of target cloud nodes connected to the cloud infrastructure, a central interface configured to provide a control over the cloud infrastructure, a plurality of Big Data applications hosted by the cloud infrastructure, and a private controlling gateway configured to provide a security to the cloud infrastructure. The cloud infrastructure further comprises a cloud administrator which is configured to implement, monitor and maintain the cloud infrastructure.

According to an embodiment herein, the Big Data applications are installed on demand and asynchronously over a cloud user platform for Big Data processing.

According to an embodiment herein, the cloud infrastructure is deployed and is configured to add additional cloud nodes depending on a cloud user requirement.

According to an embodiment herein, the central control interface further comprises an online interface configured to remotely control the cloud infrastructure, an offline interface configured to provide a privatised control to the cloud administrator and a central hub configured to combine on-premise or on-site and public cloud infrastructure.

According to an embodiment herein, the central control interface is configured to deploy, change, configure, manipulate, control, secure, sell, and rent the applications, data and infrastructure resources to the requesting cloud user.

According to an embodiment herein, the central control interface to the cloud infrastructure is configured to track an existence of all cloud nodes during their life cycle and provide a remote registration of processing nodes so as to concoct the system which is integrated with the cloud nodes.

According to an embodiment herein, each cloud node is identified by a universally unique identifier (UUID). The universally unique identifier (UUID) comprises an Internet Protocol (IP) address and a port number adopted to identify a particular cloud node.

According to an embodiment herein, the central control interface integrates the private and public resources for a resource management.

According to an embodiment herein, a web interface is provided to the cloud users at the cloud infrastructure. The web interface is configured to provide an access to the users. The web interface comprises a plurality of web service endpoints for desktop remote controlling and embedding functionalities through the remote interfaces.

According to an embodiment herein, the cloud node of the system comprises a plurality of modules. A type identifier is assigned to each module of a node so as to track the nodes and to evolve the system by adapting the specific parts in a long term. The plurality of modules comprises a plurality of software programs, a hardware infrastructure installed with an operating system, a Data Format (DF), a Networked File (NF) and a Networked Data Storage (NDS). The plurality of software programs is written by the third parties using a Package Application Virtual Machine layer such as Java Virtual machine. The software programs comprise a plurality of algorithms and a Data Loader (DL). The algorithms are configured to process the Big Data sets and the DL provides an assembly to dynamically link the algorithms. The hardware infrastructure is connected to the cloud for accessing the online websites. The hardware infrastructure is connected to the cloud through an agent owned by the marketplace. The DF decides or judges a communication process between the data consumers and producers. The NF is a file which is accessible through the network interfaces by a unique name given to associate the DL. The NDS is configured to store and retrieve the files from the cloud nodes provided with the marketing agents. The NDS comprises a plurality of geographically available interfaces to connect data sets, DLs and Algorithms. Each website available on the private/public cloud has networked data storage. The storage operates in an asynchronous and non-blocking manner to ensure a geographic based operation. The DF has a unique identifier which is categorized based on a data type, a user identity created by DF and a sequential version number. The DL contains a digital signature for the user.

According to an embodiment herein, a plurality communication protocols is provided for exchanging data within and between the cloud nodes. The plurality of communication protocols comprises an IP protocol adopted for enabling a communication between the separate cloud nodes that are distributed geographically, a HTTP protocol adopted as communication protocol configured to use REST architecture for scalability and fault tolerance of the cloud nodes and a plurality of protocol probes configured to analyze and monitor the rules followed by the communication protocol.

According to an embodiment herein, the privacy controlling gateway adopts the symmetric and asymmetric encryption protocols to secure the private cloud infrastructure and the central control interface.

The various embodiments herein provide a method for deploying a new cloud node to a cloud infrastructure. The method comprises the following steps. The cloud administrator installs an installer application on a joining/connected cloud node. The joining cloud node is registered to an online or private interface of the central control interface. The cloud user requests for the applications that are available on the cloud infrastructure. The central control interface allocates the new resources to the requested applications. The central control interface further rents the demanded/requested applications to the cloud user. The existing applications are scaled over a previous cloud infrastructure owned by the user.

The method further comprises steps of enabling the user to choose an algorithm which generates a required output over the NF. The user specifies the NDS to host the NF. The user provides references to a data set with a compatible DF that is specified by the algorithm. The user performs a check on the cloud infrastructure, to monitor an inter-compatibility of the cloud nodes.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a distributed system for providing a marketplace for Big Data applications, according to an embodiment herein.

FIG. 2 illustrates a flowchart explaining the steps involved in a method for deploying a new cloud node to a cloud infrastructure, according to an embodiment herein.

FIG. 3 illustrates a functional block diagram of system architecture for big data marketplace, according to an embodiment herein.

FIG. 4 illustrates a flowchart explaining a method for adding new node to a cloud infrastructure, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein disclose a system for providing a marketplace for Big Data applications. The system comprises a cloud infrastructure configured to adapt, port and deploy Big Data applications to a plurality of target cloud nodes connected to the cloud infrastructure, a central interface configured to provide a control over the cloud infrastructure, a plurality of Big Data applications hosted by the cloud infrastructure, and a private controlling gateway configured to provide a security to the cloud infrastructure. The cloud infrastructure further comprises a cloud administrator which is configured to implement, monitor and maintain the cloud infrastructure.

According to an embodiment herein, the Big Data applications are installed on demand and asynchronously over a cloud user platform for Big Data processing.

According to an embodiment herein, the cloud infrastructure is deployed and is configured to add additional cloud nodes depending on a cloud user requirement.

According to an embodiment herein, the central control interface further comprises an online interface configured to remotely control the cloud infrastructure, an offline interface configured to provide a privatised control to the cloud administrator and a central hub configured to combine on-premise or on-site and public cloud infrastructure.

According to an embodiment herein, the central control interface is configured to deploy, change, configure, manipulate, control, secure, sell, and rent the applications, data and infrastructure resources to the requesting cloud user.

According to an embodiment herein, the central control interface to the cloud infrastructure is configured to track an existence of all cloud nodes during their life cycle and provide a remote registration of processing nodes so as to concoct the system which is integrated with the cloud nodes.

According to an embodiment herein, each cloud node is identified by a universally unique identifier (UUID). The universally unique identifier (UUID) comprises an Internet Protocol (IP) address and a port number adopted to identify a particular cloud node.

According to an embodiment herein, the central control interface integrates the private and public resources for a resource management.

According to an embodiment herein, a web interface is provided to the cloud users at the cloud infrastructure. The web interface is configured to provide an access to the users. The web interface comprises a plurality of web service endpoints for desktop remote controlling and embedding functionalities through the remote interfaces.

According to an embodiment herein, the cloud node of the system comprises a plurality of modules. A type identifier is assigned to each module of a node so as to track the nodes and to evolve the system by adapting the specific parts in a long term. The plurality of modules comprises a plurality of software programs, a hardware infrastructure installed with an operating system, a Data Format (DF), a Networked File (NF) and a Networked Data Storage (NDS). The plurality of software programs is written by the third parties using a Package Application Virtual Machine layer such as Java Virtual machine. The software programs comprise a plurality of algorithms and a Data Loader (DL). The algorithms are configured to process the Big Data sets and the DL provides an assembly to dynamically link the algorithms. The hardware infrastructure is connected to the cloud for accessing the online websites. The hardware infrastructure is connected to the cloud through an agent owned by the marketplace. The DF decides or judges a communication process between the data consumers and producers. The NF is a file which is accessible through the network interfaces by a unique name given to associate the DL. The NDS is configured to store and retrieve the files from the cloud nodes provided with the marketing agents. The NDS comprises a plurality of geographically available interfaces to connect data sets, DLs and Algorithms. Each website available on the private/public cloud has networked data storage. The storage operates in an asynchronous and non-blocking manner to ensure a geographic based operation. The DF has a unique identifier which is categorized based on a data type, a user identity created by DF and a sequential version number. The DL contains a digital signature for the user.

According to an embodiment herein, a plurality communication protocols is provided for exchanging data within and between the cloud nodes. The plurality of communication protocols comprises an IP protocol adopted for enabling a communication between the separate cloud nodes that are distributed geographically, a HTTP protocol adopted as communication protocol configured to use REST architecture for scalability and fault tolerance of the cloud nodes and a plurality of protocol probes configured to analyze and monitor the rules followed by the communication protocol.

According to an embodiment herein, the privacy controlling gateway adopts the symmetric and asymmetric encryption protocols to secure the private cloud infrastructure and the central control interface.

The various embodiments herein provide a method for deploying a new cloud node to a cloud infrastructure. The method comprises the following steps. The cloud administrator installs an installer application on a joining/connected cloud node. The joining cloud node is registered to an online or private interface of the central control interface. The cloud user requests for the applications that are available on the cloud infrastructure. The central control interface allocates the new resources to the requested applications. The central control interface further rents the demanded/requested applications to the cloud user. The existing applications are scaled over a previous cloud infrastructure owned by the user.

The method further comprises steps of enabling the user to choose an algorithm which generates a required output over the NF. The user specifies the NDS to host the NF. The user provides references to a data set with a compatible DF that is specified by the algorithm. The user performs a check on the cloud infrastructure, to monitor an inter-compatibility of the cloud nodes.

The various embodiments herein provide a system and method for providing a marketplace for Big Data applications. The system facilitates a repository of applications, data sets, process compositions and extension modules received from the various vendors. The assets provided by the marketplace are deployable upon receiving the requests on public and private clouds.

The marketplace comprises a plurality of algorithms, data sets and software systems offered together to create the system that generates, shares and saves insights for a plurality of cloud users. The system is operated manually and is configured to adopt the machines for a system processing. The marketplace provides a plurality of data vendors to access to infrastructure. The marketplace further provides the software platforms for a storage of the Big Data applications. The marketplace also provides the reusable algorithms for processing based on the predefined structures and procedures. The data vendors rent the data sets through the marketplace and charge the cloud users for updates.

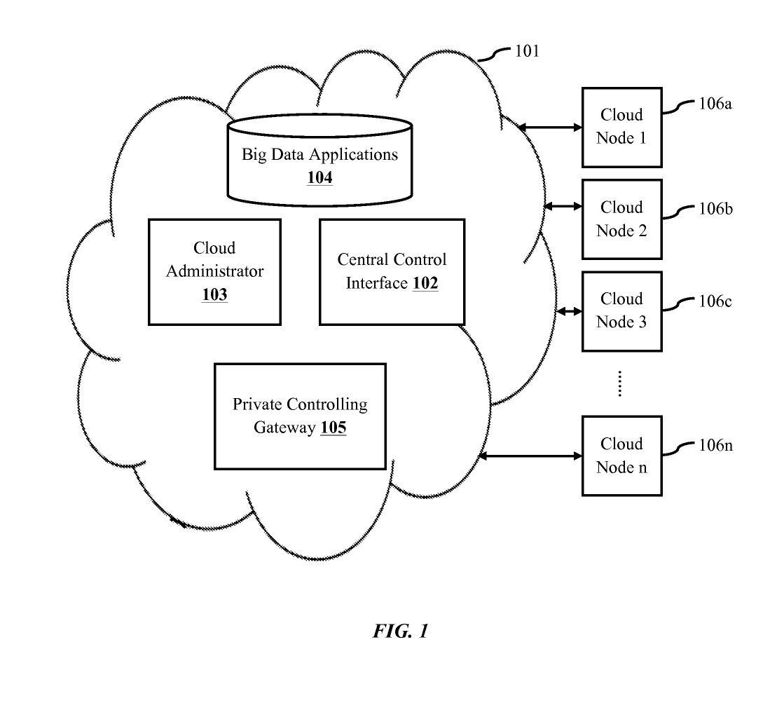

FIG. 1 illustrates a block diagram of a distributed system for a marketplace for Big Data applications, according to an embodiment herein. With respect to FIG. 1, the system comprises a cloud infrastructure 101, a plurality of cloud nodes 106a, 106b, 106c, . . . , 106n, a central control interface 102, a plurality of Big Data applications 104 and a private controlling gateway 105. The cloud infrastructure 101 is configured to adopt or configure, port and deploy Big Data applications 104 to the plurality of target cloud nodes 106 connected to the cloud infrastructure 101. The cloud infrastructure 101 further comprises a cloud administrator 103 configured to implement, monitor and maintain the cloud infrastructure 101. The plurality of Big Data applications 105 are hosted by the cloud infrastructure 101. The central control interface 102 is configured to provide a cloud user with control over the cloud infrastructure 101.

The cloud infrastructure is deployed by connecting the additional cloud nodes depending on the cloud user requirement. The system provides Big Data applications on demand from the cloud user and installs the demanded or requested application on to a dedicated platform adopted for an online Big Data processing.

The system provides a remote administration or control for the cloud infrastructure with a controlling stub installed over the privately owned infrastructures. The controlling stub is fetched through an online repository and is installed on the public clouds or any other computation facility affording to run the application virtual machines. The central system eliminates the need for an on-site administration of the cloud platform and applications. The applications are installed on demand and asynchronously over the dedicated platform for Big Data processing online and the control is provided to the central hub.

The available Big Data applications on the cloud infrastructure are signed and registered publicly or privately to the enterprise with the help of central interface. Every enterprise provides an authorization and controls an authentication of the data, platform and the applications.

The central interface of the system provides a double interface for combining on-premise or on-site and public cloud infrastructures through an online hub. The central system comprises an online interface configured to remotely control the cloud infrastructure and an off-line interface configured to provide a privatized control to the cloud through a cloud administrator. The central interface further comprises a central hub configured to connect the on-premise or on-site and public cloud nodes. The central hub is configured to synchronize the various actions performed by the private and public cloud nodes. The central control interface is configured to deploy, change, configure, manipulate, control, secure, sell, and rent the applications, data and infrastructure resources to the requesting cloud user. The central control interface to the cloud infrastructure is further configured to track the existence of all cloud nodes during a life cycle and provide a remote registration of the processing nodes so as to develop the system that is integrated with the cloud nodes.

The system further comprises a web interface provided to the cloud users at the cloud infrastructure. The web interface is configured to provide an access to the users. The web interface comprises a plurality of web service endpoints for the desktop remote controlling and embedding functionalities through remote interfaces. The web console provides a ubiquitous connection to all the machines/devices and operating systems distributed anywhere. The communication between the various machines/devices is done through a Universal Unique Identifier (UUID) of the cloud cluster. The user registers with the required UUID and then accesses the cluster through a web interface. The system uses an IP address and port number to identify the nodes to acquire or have the UUID. The user chooses a UUID for the cluster to eliminate the need for a pre-registration of the cluster. The validity of UUID and an associated name is registered online for a future identification.

The cloud node of the system comprises a plurality of modules. A type or typical identifier is assigned to each module of a node so as to track the nodes and to evolve the system by adapting or configuring the specific parts in a long term. The plurality of modules comprises a plurality of software programs, a hardware infrastructure installed with an operating system, a Data Format (DF), a Networked File (NF) and a Networked Data Storage (NDS). The plurality of software programs is written by the third parties using a Package Application Virtual Machine layer such as Java Virtual machine. The software programs comprise a plurality of algorithms and a Data Loader (DL). The algorithms are configured to process the Big Data sets and the DL provides an assembly to dynamically link the algorithms. The hardware infrastructure is connected to the cloud for accessing the online websites. The hardware infrastructure is connected to the cloud through an agent owned by the marketplace. The DF decides or judges or selects a communication process between the data consumers and producers. The NF is a file which is accessible through the network interfaces by a name given to associate DL. The NDS is configured to store and retrieve the files from the cloud nodes having marketing agents. The NDS comprises a plurality of geographically available interfaces to connect the data sets, DLs and Algorithms. Each website available on the private/public cloud has a networked data storage. The storage operates in an asynchronous and non-blocking manner to ensure a geographic based operation. The DF has a unique identifier which is categorized based on a data type, a user identity created by DF and a sequential version number. The DL contains a digital signature for the user.

A hierarchical document is transferred between the data consumers and producers through websites. The Data format of the hierarchical document is convertible to XML, YAML and JSON standards. The format is independent of the plurality of applications and vendors and is open for an update and editing by the users. Each Data Format (DF) has a unique identifier which is categorized based on a data type, a user identity and a sequential version number. The user identity is created by the DF. Any user is able to copy and modify the DF according to the usage. The signature of the DF Identifier comprises <username, type, version>. The DF is not backward compatible and is identified only with the three tuples. The modification of DF as a human readable document enables the marketplace to eventually find the matured and shareable DFs among the partners. Eventually some DFs have become prevalent among the adaptors and a lot of applications depend on the DFs. Such mechanism makes the marketplace to be evaluated and gives inherent governance to one provided with ability to design better DFs and marketing. The DF owners request charges by licensing the methods to make money from the applications. The owners are able to restrict the usage of DFI as a trigger to receive money especially after a lot of users have accepted or agreed for payment (to pay). The DF is a list of columns of data in the data set. The columns types of DF are textual tag symbols (TGS) without any limitations and applications which are responsible to know about the data. Each column has an identifier (ID) and an optional discriminator (OD). Hence the DF element is a three tuple element: <ID, TGS, OD>.

The algorithms at the cloud nodes are under version control and are identified adopting three element tuples <Name, User ID, Version>, similarly like DFs. The identification eventually leads to the vendors having stable versions. The system has automatic compilation tool chain to get the binaries from a source code upon execution.

The data set need to specify the DL to dynamically link the plurality of algorithms. The DL is a short computer program packaged as an assembly for linking dynamically with the algorithms. The DL has a digital signature of the user. The algorithm requires the DF and the DL acts as a service provider of the DF. The DL loads the data from Data Set, converts the data to the representation/format according to the algorithm and delivers the data, after the data is read once by the algorithm. The DL accesses the network resources from Cloud or local storages, which are accessible through network interface, in order to eliminate the possibility of security breaches for public deployments. Some DLs set or assign the standards for data input and provides a flexibility to choose the source and the reusability of the source and standards for different data sets.

The Marketplace tracks nodes, data sets and applications as algorithms and platforms as software bundles. The marketplace uses own protocols and regulations, to provide a compatible to the data sets. The Marketplace uses the regulations to integrate the data sets together. The system adopts a plurality communication protocols for exchanging the data within and between the cloud nodes. The plurality of communication protocols comprises an IP protocol adopted for enabling a communication between the separate cloud nodes that are distributed geographically, a HTTP protocol adopted as a communication protocol configured to use a REST architecture for scalability and fault tolerance of the cloud nodes and a plurality of protocol probes that are configured to analyze and monitor the rules followed by the communication protocol.

The private controlling gateway of the system adopts the symmetric and asymmetric encryption protocols to secure the private cloud infrastructure and the central control interface. The private controlling gateway creates a trust or confidence using similar mechanism between the pre-owned nodes.

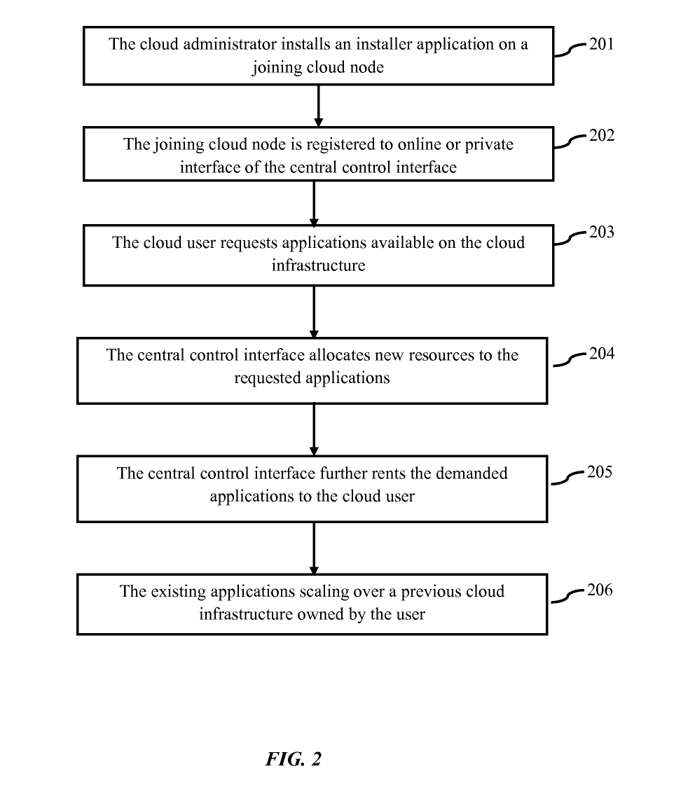

FIG. 2 illustrates a flowchart explaining the steps involved in a method for deploying a new cloud node to a cloud infrastructure, according to an embodiment herein. The method comprises the following steps. The cloud administrator installs an installer application on a joining or connected cloud node (201). The joining or connected cloud node is registered to online or private interface of the central control interface (202). The remote registration of processing nodes enables the system to integrate with the cloud nodes. The cloud user requests applications that are available on the cloud infrastructure (203). The central control interface allocates the new resources to the requested applications (204). The central control interface further rents the demanded or requested applications to the cloud user (205). The existing applications are scaled over a previous cloud infrastructure owned by the user (206).

The method further comprises the steps of the user to choose an algorithm which generates a required output over the NF. The user specifies the NDS to host the NF. The user provides references to a data set with a compatible DF that is specified by the algorithm. The user performs a check on the cloud infrastructure, to monitor an inter-compatibility of the cloud nodes.

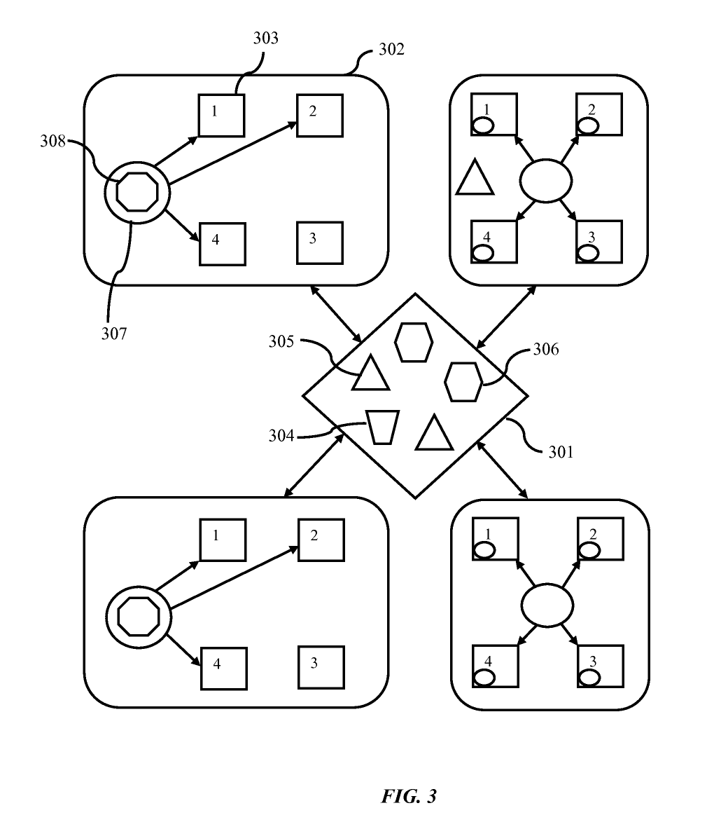

FIG. 3 illustrates a system architectural diagram for big data marketplace, according to an embodiment herein. The system adapts, ports and deploys big data applications to the plurality of target cloud nodes connected to the cloud infrastructure. The central interface is configured to provide a control over the cloud infrastructure. The central interface comprises a central hub 301 configured to connect on-premise or on-site and public cloud clusters 302. The central hub 301 is configured to synchronize various actions performed by the private and public cloud clusters 302. The cloud cluster comprises a plurality of execution nodes 303. The central control interface is configured to deploy, change, configure, manipulate, control, secure, sell, and rent the applications, data and infrastructure resources to the requesting cloud user. The cloud node of the system comprises a plurality of modules. A type identifier is assigned to each module of a node so as to track the nodes and to evolve the system by adapting the specific parts in long term. The plurality of modules comprises a plurality of software programs, a hardware infrastructure installed with an operating system, a Data Format (DF) 306, a Networked File (NF) and a Networked Data Storage (NDS). The plurality of software programs are written by the third parties using Package Application Virtual Machine layer such as Java Virtual machine. The software programs comprise a plurality of algorithms 304 and a Data Loader (DL) 305. The algorithms 304 are configured to process big data sets and the DL 305 provides an assembly to dynamically link the algorithms 304. The hardware infrastructure is connected to the cloud for accessing the online websites. The hardware infrastructure connects to the cloud through an agent owned by the marketplace. The DF 306 decides or judges or selects a communication process between the data consumers and producers. The NF is a file which is accessible through network interfaces by a name given to associate DL 305. The NDS 307 is configured to store and retrieve a collection of files 308 from the cloud nodes having marketing agents. The NDS comprises a plurality of geographically available interfaces to connect data sets, DLs and Algorithms. Each website available on the private/public cloud has networked data storage. The storage operates asynchronous and non-blocking to ensure geographic operability. The DF 306 has a unique identifier categorized based on data type, user identity created by DF 306 and a sequential version number. The DL 305 contains a digital signature for the user.

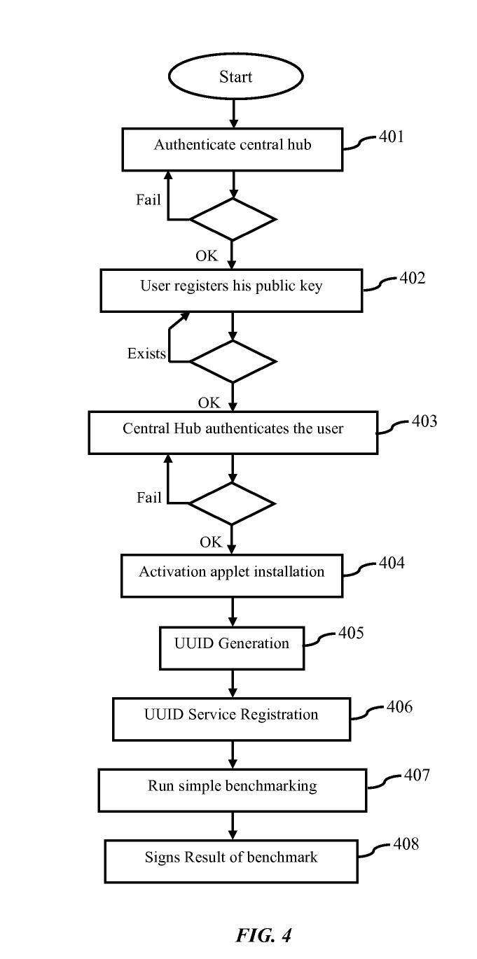

FIG. 4 illustrates a flowchart explaining the steps involved in a method for adding new node to a cloud infrastructure, according to an embodiment herein. The method comprises the following steps. The authentication of central hub is performed (401). The user is registered to the cloud infrastructure by providing a respective public key (402). On registration, the central hub authenticates the user by decrypting the public key provided (403). The cloud administrator installs the installer application on the user platform and activates the application (404). After an installation of an application, the user is provided with a UUID for user identification (405). The user registers to the cloud cluster with the acquired UUID and then accesses the cluster through web interface (406). The cloud cluster performs a simple benchmarking assess the relative performance of the user (407) and generates a benchmark result to the central hub (408).

The renting features of the marketplace are provided across the boundaries/limits of a company. The applications of the marketplace are rented on demand and across the world. The Big Data operating system and execution platforms create an availability of required software modules anywhere on any commodity hardware. The Big Data operating system and execution platforms make the required software modules to be available easily at anywhere on any commodity hardware The available datasets are registered, versioned and transfer across the world, across an enterprise and across a single data center. The user is allowed or able to use the facilities through the central hub and is accessible anywhere through an internet connection. The remote controlling of Big Data applications are given through the Big Data operating system. The service provides a data sharing opportunity on the infrastructure to enable the owner to share, sell, rent or transfer the data assets regardless of being located at an on-premises/on-site or on public clouds and provide authentication and security control to the owner. The marketplace organizes the modules with specific predefined procedures and rules to ensure a compatibility and interoperability of a geographically distributed software and hardware parts. The plurality of procedures, restrictions and rules are implemented/executed with the marketplace operating system.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A system for providing a marketplace for Big Data applications, the system comprising:
a cloud infrastructure configured to adapt, port and deploy a plurality of Big Data applications to a plurality of target cloud nodes, and wherein the plurality of Big Data applications is connected to and hosted by the cloud infrastructure;
a central control interface configured to provide a control over the cloud infrastructure; and
a private controlling gateway configured to provide a security to the cloud infrastructure;
wherein the cloud infrastructure comprises a cloud administrator, and wherein the cloud infrastructure is configured to implement, monitor and maintain the cloud infrastructure.

2. The system according to claim 1, wherein the Big Data applications are installed on demand and asynchronously over a cloud user platform for Big Data processing.

3. The system according to claim 1, wherein the cloud infrastructure is deployed and is configured to add additional cloud nodes based on a cloud user requirement.

4. The system according to claim 1, wherein the central control interface further comprises:
an online interface configured to remotely control the cloud infrastructure;
an off-line interface configured to provide a privatised or personalised control to the cloud administrator; and
a central hub configured to combine an on-premise or on-site and public cloud infrastructure.

5. The system according to claim 1, wherein the central control interface is configured to deploy, change, configure, manipulate, control, secure, sell, and rent the applications, data and infrastructure resources to the requested cloud user.

6. The system according to claim 1, wherein the central control interface is configured to track an existence of a plurality of cloud nodes during a life cycle and provide a remote registration of processing nodes to configure a system that is integrated with the plurality of cloud nodes.

7. The system according to claim 1, wherein each cloud node is identified by a universal unique identifier (UUID), and wherein the universal unique identifier (UUID) comprises an Internet Protocol (IP) address and a port number adopted to identify a preset cloud node.

8. The system according to claim 1, wherein the central control interface integrates private and public resources for managing a cloud resource.

9. The system according to claim 1 further comprises a web interface provided to the cloud users at the cloud infrastructure, and wherein the web interface is configured to provide an access to the cloud users, and wherein the web interface comprises a plurality of web service endpoints for desktop remote controlling and embedding functionalities through remote interfaces.

10. The system according to claim 1, wherein the cloud nodes comprises a plurality of modules and wherein each module of the cloud nodes is assigned with a type identifier or class identifier to track the cloud nodes and to develop the system by adapting specific parts in a long term.

11. The system according to claim 10, wherein the plurality of modules comprises:
software programs written by third parties using Package Application VM Layer Library, and wherein the software programs comprises a plurality of algorithms, and wherein the plurality of algorithms is configured to process Big Data sets and a Data Loader (DL) and wherein the DL provides an assembly to dynamically link the algorithms;
hardware infrastructures installed with a plurality of systems, and wherein the plurality of systems is connected to the cloud for accessing the online websites;
data format (DF) for selecting a communication process for data consumers and producers;
networked file (NF), and wherein the NF is accessible through the network interfaces by a name given to an associated DL;
Networked Data Storage (NDS) configured to store and retrieve the networked files from the plurality of cloud nodes, and wherein the plurality of cloud nodes is provided with a plurality of marketing agents;
wherein DF has a unique identifier, and wherein the unique identifier is categorized based on a data type, a user identity created by DF and a sequential version number, and wherein the DL contains a digital signature for the user.

12. The system according to claim 1, further comprises a plurality communication protocols for exchanging data within and between the plurality of cloud nodes.

13. The system according to claim 12, and wherein the plurality of communication protocols comprises:
an IP protocol adopted for enabling a communication between a plurality of individual cloud nodes that are distributed geographically;
a HTTP protocol adopted as a communication protocol and wherein the HTTP protocol is configured to use REST architecture for enabling a scalability and fault tolerance of the cloud nodes; and
a plurality of protocol probes configured to analyze and monitor a plurality of rules followed by the communication protocol.

14. The system according to claim 1, wherein the private controlling gateway adopts symmetric and asymmetric encryption protocols to secure the private cloud infrastructure and the central control interface.

15. A method for deploying a new cloud node to a cloud infrastructure, the method comprising steps of:
installing an installer application on a joining cloud node or connected cloud node, by the cloud administrator;
registering the joining cloud node or connected cloud node to an online interface or a private interface in a central control interface;
requesting for a plurality of applications available on the cloud infrastructure by a cloud user;
allocating a plurality of new resources to the requested applications by the central control interface;
renting the requested applications to the cloud user by the central control interface; and
scaling the existing applications over a previous cloud infrastructure owned by the user or a pre-owned cloud infrastructure.

16. The method according to claim 15, wherein the method further comprises:
choosing an algorithm by the user, and wherein the algorithm is executed to generate a required output over a networked file (NF);
specifying Networked Data Storage (NDS) to host the NF by the user;
providing references to a data set by the user, and wherein the data set is compatible to DF and wherein the DF is specified by an algorithm;
performing a check on the cloud infrastructure to monitor an inter-compatibility of the plurality of cloud nodes.
